(19) United States
(12) Patent Application Publication
(10) Pub. No.: US 2004/0226030 A1
(43) Pub. Date: Nov. 11, 2004

(54) Systems and methods for an extensible software proxy

(76) Inventors: Kyle Marvin, Kingwood, TX (US); David Read, Bellevue, WA (US); David Bau, Gladwyne, PA (US)

Correspondence Address: FLIESLER MEYER, LLP, FOUR EMBARCADERO CENTER, SUITE 400, SAN FRANCISCO, CA, 94111, US

(21) Appl. No.: 10/780,346

(22) Filed: Feb. 17, 2004

Related U.S. Application Data
(60) Provisional application No. 60/451,352, filed on Feb. 28, 2003.

(51) Int. Cl. G06F 9/46

(52) U.S. Cl. 719/328

(57) ABSTRACT

A system and method for creating a proxy object capable of communication with an external entity, comprising specifying a proxy object definition for the proxy object wherein the proxy object definition defines a first function for communicating with the external entity, specifying at least one implementation class for the proxy object definition, wherein the at least one implementation class does not implement the first function, and wherein the at least one implementation class includes functionality to support one of: proxy object design, software compilation and software execution.

### CLAIM OF PRIORITY

This application claims priority from the following application, which is hereby incorporated by reference in its entirety:

SYSTEMS AND METHODS FOR AN EXTENSIBLE CONTROLS ENVIRONMENT, U.S. Application No. 60/451,352, Inventors: Kyle Marvin et al., filed on Feb. 28, 2003 (Attorney's Docket No. BEAS-1444US0)

### CROSS-REFERENCE TO RELATED APPLICATIONS

This application is related to the following co-pending application which is hereby incorporated by reference in its entirety:

SYSTEMS AND METHODS FOR CREATING NETWORK-BASED SOFTWARE SERVICES USING SOURCE CODE FOR ANNOTATIONS, U.S. Application No. ______, Inventors: Kyle Marvin et al., filed on ______. (Attorney's Docket No. BEAS-1445US1)

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Software proxies (or “proxies”) have found widespread use since their use allows a software developer to utilize functionality external to an application as though it was local to the application. Thus, the developer can focus on developing the application at hand rather than being concerned with the complex details of how communication with an external entity is accomplished. While proxies can be a great tool for software developers, modifying their functionality can involve considerable complexity. What is needed is a simpler way modify proxies.

### FIELD OF THE DISCLOSURE

The present invention disclosure relates systems and methods for modifying software proxies.

### BRIEF DESCRIPTION OF THE DRAWINGS

FIG. 1 is an exemplary system illustration in an embodiment.

FIG. 2 is exemplary operations a developer or design tool can take to develop a proxy object definition in an embodiment.

FIG. 3 is exemplary operations a developer or design tool can take to define a proxy object in accordance to an embodiment.

FIG. 4 is an exemplary proxy object definition of an external timer entity in accordance to an embodiment.

FIG. 5 is an exemplary proxy object implementation in accordance to an embodiment.

FIG. 6 is an exemplary property syntax in accordance to an embodiment.

FIG. 7 is an exemplary application development method in accordance with an embodiment.

Figured 8a is an exemplary proxy declaration in an embodiment.

FIG. 8b is another exemplary proxy declaration in an embodiment.

FIG. 8c is an exemplary asynchronous event handler for handling asynchronous timeout event notifications in an embodiment.

FIG. 9a is an exemplary proxy object definition that extends an interface in an embodiment.

FIG. 9b is an exemplary proxy object definition in an embodiment.

FIG. 10a illustrates exemplary operational flow of a compiler in accordance to an embodiment.

FIG. 10b illustrates exemplary operational flow of a compiler in accordance to an embodiment.

FIG. 11 illustrates an exemplary proxy object in accordance to an embodiment.

FIG. 12a illustrates operational flow of an exemplary runtime engine in accordance to an embodiment.

FIG. 12b illustrates a typical execution flow, in accordance with one embodiment.

FIG. 13a illustrates an exemplary proxy object factory declaration in accordance to an embodiment.

FIG. 13b illustrates generation of a new instance a “Timer” proxy object in accordance to an embodiment.

FIG. 13c illustrates an event handler in accordance to an embodiment.

### DETAILED DESCRIPTION

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

An embodiment allows the developer to achieve these goals though the use of an extensible source code annotation system. A complier can automatically recognize information supplied in annotations to extend proxies. Some embodiments include a proxy architecture that supports a number of capabilities including:

Simplifying Development;

Facilitating integration with external subsystems; and

Facilitating code reuse.

The term “external entity” refers to “external” hardware as well as software entities. “External” is viewed from the perspective of the software application interacting with the entity.

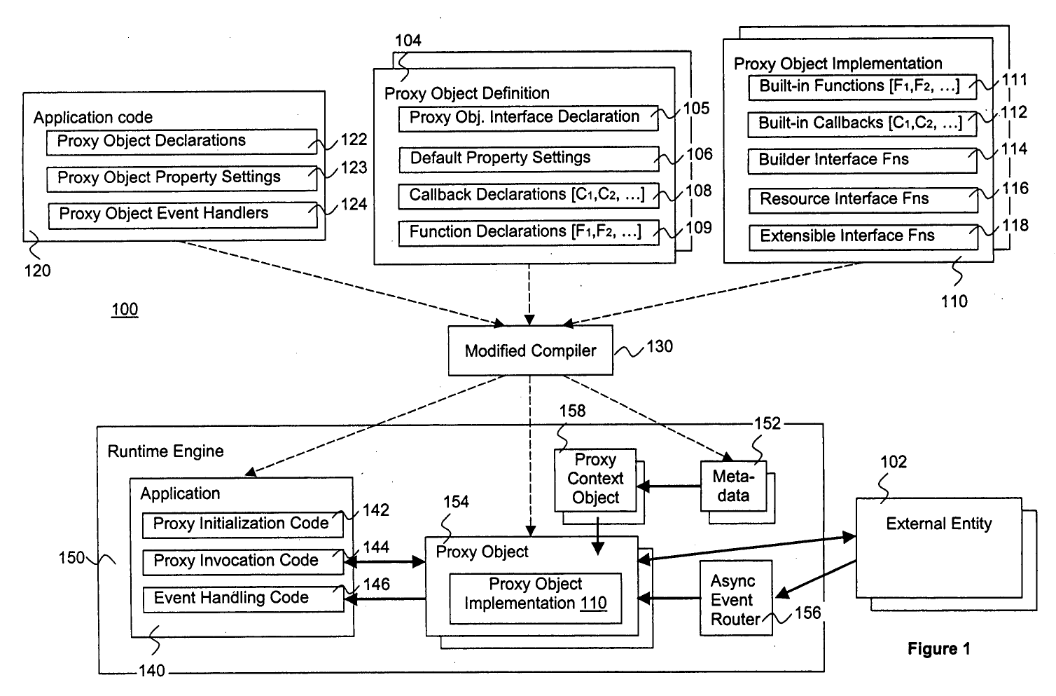

FIG. 1 illustrates an overview of an embodiment, in accordance with one embodiment. As illustrated, to simplify developing software applications 140 that interact with external entities 102, an embodiment provides methodologies and facilities to provide proxy objects 154 for external entities 102, such that software application 140 can interact with external entity 102 programmatically using general purpose programming concepts familiar to software developers.

More specifically, a developer can create a proxy object definition 104 for external entity 102. The developer can be the developer of external entity 102, a third party developer, or even the developer of application 140.

Proxy object definition 104 includes interface declaration 105 identifying that a proxy object 154 should be generated based on the definition for interacting with an external entity. Further proxy objection definition 104 includes default property settings 106 for defining the default behavior and default implementation 110 of proxy object 154, callback declarations 108 for handling asynchronous events from external entity 102 and function declarations 109 for initiating interactions with external entity 102.

In one embodiment, the one or more proxy object implementation classes 110 include a run-time implementation class. In another embodiment, the one or more implementation classes 110 further include a compile-time implementation class. In yet another embodiment, implementation classes 110 further include a design-time implementation class.

The run-time implementation class provides the run-time implementations for the functions declared in proxy object declaration 104 and used by software application code 120 to interact with external entity 102 programmatically. The run-time implementation class can provide one or more built-in functions 111 for initiating interaction with external entity 102 and one or more built-in callbacks 112 for handling asynchronous events generated by external entity 102.

The optional compile time implementation class provides the compile time validation implementation to assist compiler 130 in validating usage of the functions and property settings by proxy object definition 104 and by application code 120, during compilation.

The optional design-time implementation class provides the design-time implementation for assisting developers of proxy object definitions 104 and application code 120. It assists developers to extend and use properties and functions implemented by the run-time implementation for interacting with external entity 102 programmatically. An example of such design-time implementation includes but is not limited to a graphical wizard that guides the developer through the creation of a proxy object definition for a specific external web service given the WSDL description of that web service. Another example is the provision of graphic icons corresponding to usage of the functions of proxy object definition 104, which when selected for a application code 120, inserts the corresponding function call into the application code 120.

For the illustrated embodiment, the proxy object implementation 110 can implement one or more interfaces 114-118. In particular, for the embodiment, proxy object implementation 110 can implement builder interface 114, resource interface 116, and extensible interface 118.

Builder interface 114 can be implemented by the compile-time component of proxy object implementation 110 to assist compiler 130 in validating the usage of properties and functions implemented by proxy object implementation 110. Resource interface 116 can be implemented by the run-time component of proxy object implementation 110 to acquire and release critical resources, such as databases and file handles, needed by the proxy object implementation. Extensible interface 114 can be implemented by the run-time component of proxy object implementation 110 to enable proxy object definitions 104 to declare new functions not built-in to proxy object implementation 110.

Still referring to FIG. 1, once proxy object definition 104 and implementation 110 are created, a developer of application code 120 can equip application 140 to initiate interactions with external entity 102 by including proxy object declarations 122 and invoking declared functions 109 on the resulting proxy objects. Application code can also include property settings 123 to customize the behavior of proxy objects or include event handlers 124 to process asynchronous events generated by external entity 102.

Software application code 120, proxy object definitions 104, and proxy object implementations 110 equipped in accordance with an embodiment are compiled into application 140, proxy objects 154, and meta-data 152 using enhanced compiler 130.

Compiler 130 is enhanced to recognize proxy object definitions 104 and generate associated proxy objects 154 using proxy object implementations 110 to facilitate interaction with software entity 102 at runtime. Compiler also generates proxy initialization code 142 that creates a proxy object for each proxy object declaration 122, assigns the proxy object to the declared variable, and registers the proxy object with asynchronous event router 156 to receive appropriate events generated by the associated external entity 102. Further, compiler 130 is enhanced to gather and output meta-data 152 describing the interfaces, functions, callbacks and property settings of property object definitions 104 for use by the corresponding proxy object 154 at runtime.

Still referring to FIG. 1, execution of compiled object code during runtime is under the control of runtime engine 150. Runtime engine 150 includes in particular, proxy context objects 158, an instance of which is created for each proxy object invocation for interacting with an instance of external entity 102 and maintaining the state information of the particular interaction. For the embodiment, interaction context 158 includes a number of methods through which proxy object implementation 110 can obtain information about a particular interaction.

For the embodiment, as described earlier, proxy object definition 104 can declare one or more callback functions 108 for handling asynchronous events generated by corresponding external entity 102. Complementarily, runtime engine 150 includes asynchronous event router 156 for listening for, receiving, and routing asynchronous events generated by external entity 102 to appropriate proxy objects 154 for processing by event handling code 146 of application 140. The locations listened to by asynchronous event router 156 are specified by proxy initialization code 142 based on proxy object implementation 110 and associated property settings 106 and 123.

Using the mechanisms described above, developers can create application code 120 to interact with external entities 102 by invoking functions on declared proxy objects 122, setting proxy object properties 123 and defining event handlers 124. Interacting with external entities in this way is very similar to interacting with other software objects and does not require the developer to learn excessive new paradigms, skills and/or techniques. In addition, developers can create new proxy object definitions 104, even with new functions and callbacks without specifying the implementation of the new functions or callbacks. The resulting proxy objects 154 in cooperation with run-time engine 150 handle multiple simultaneous and asynchronous interactions with external entity 102. In various embodiments, the external entity 102 can be a web service, a database, or a legacy system, as well as physical objects.

Provision of the optional design time implementation class is not an essential aspect to practice an embodiment. Moreover, it is within the ability of those ordinarily skilled in the art, thus will not be further described. Other aspects of an embodiment will be further described in turn below.

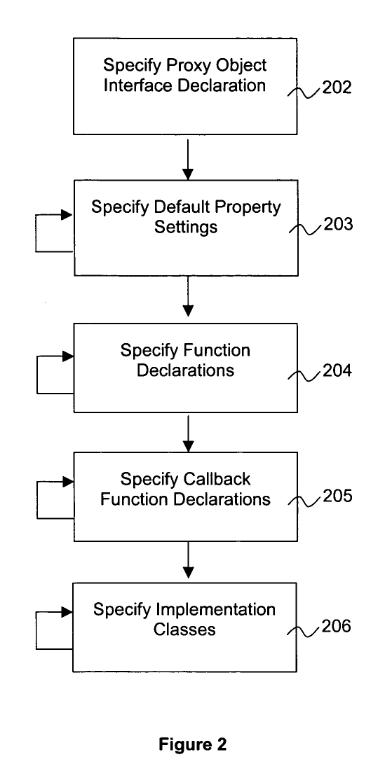

FIG. 2 illustrates the operations a developer or design-time tool can take to develop a proxy object definition 104 of an embodiment in further detail, in accordance with one embodiment. As illustrated, and alluded to earlier, one of the actions to be taken to create proxy object definition 104 is to specify a proxy object interface declaration 105, block 202.

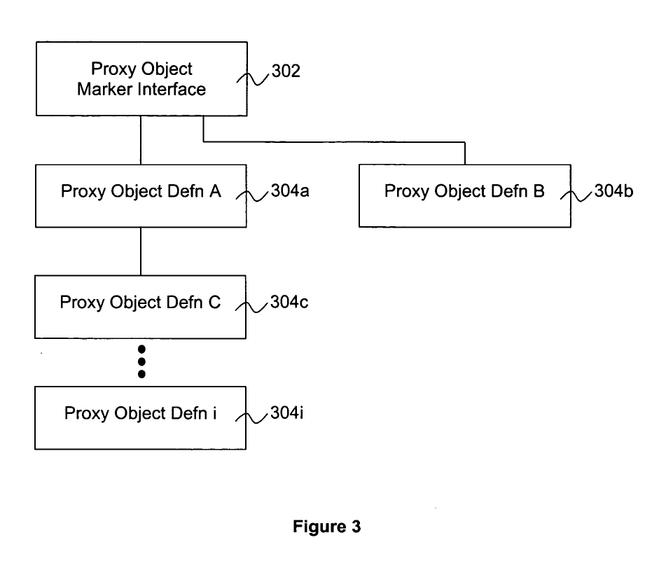

In one embodiment, this is achieved by declaring that proxy object definition 104 extends a special “proxy object” marker interface (302 of FIG. 3). As illustrated in FIG. 3, the extension of the marker interface 302 can be direct, as in the cases of proxy object definitions 304a-304b or indirect, as in the cases of proxy object definitions 304c-304i. At compile-time, enhanced compiler 130 will identify proxy object definitions 104 by finding interfaces that extend marker interface 302 and will generate proxy objects for each such interface. If the extension of the marker interface 302 is indirect, proxy object definition 104 will inherit the functions, properties and callbacks of the other proxy object definitions it extends (e.g., proxy object definition 304i will inherit the functions, properties and callbacks defined by proxy objects 304c and 304a).

Referring back to FIG. 2, as illustrated, and alluded to earlier, another action to be taken to create proxy object definition 104 is to specify the default property settings for the proxy object definition, block 203. These settings will be used at run-time by proxy object implementation 110 to determine the behavior of proxy object 154. Further, the programmer or design-time tool can optionally specify function declarations 109 of proxy object definition 104, block 204. Application code 120 can use the declared functions to programmatically interact with external entity 102. Function declarations 109 can correspond to built-in functions 111 of proxy object implementation 110, or if proxy object implementation 110 implements extensible interface 114, function declarations 109 can introduce new functions not provided explicitly by proxy object implementation 110.

In addition, the programmer or design-time tool can optionally specify callback function declarations 108 representing asynchronous events that can be generated at run-time by external entity 102. Callback function declarations 108 can correspond to built-in callback functions 112 of proxy object implementation 110, in which case proxy object 154 will route corresponding asynchronous events generated by external entity 102 to proxy object implementation 110 for processing (which can, in turn, route them to event handling code 146 of application 140). When callback function declarations 108 do not correspond to built-in callback functions 112 of proxy object implementation 110, proxy object 154 will route corresponding asynchronous events generated by external entity 102 directly to event handling code 146 of application 140.

Further, the developer or design-time tool can specify the implementation classes of the proxy object definition 104, which includes the runtime implementation class, and optionally, the compile time implementation class and/or the design time implementation class, block 206. Proxy object definition 104 need not specify implementation classes if it extends another proxy object definition that specifies implementation classes. In this case, the implementation class specifications are inherited from the extended proxy object definition.

In one embodiment, specifications of the implementation classes are made using property settings. In one embodiment, property settings are specified in an annotation form, i.e. in what is conventionally considered to be comments of a source file.

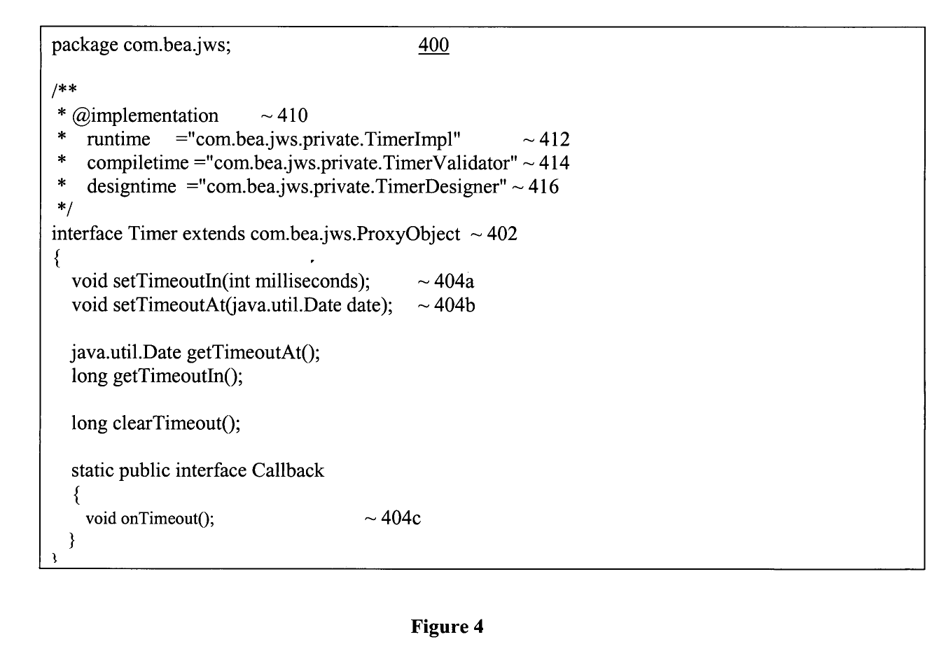

FIG. 4 illustrates an example proxy object definition of an external timer entity. Those skilled in the art will recognize this as a familiar Java interface definition extending an existing interface called com.bea.jws.ProxyObject on line 402 and including some special JavaDoc comments on lines 410-416. The Timer interface is identified as a proxy object definition of an embodiment through declaration 402 specifying the Timer interface extends the “ProxyObject” marker interface of an embodiment. In this case, the Timer interface extends the ProxyObject marker interface directly; however, it is also possible to extend the ProxyObject marker interface indirectly as depicted in FIG. 4.

Further, the Timer interface is specified as having a setTimeoutIn(int milliseconds) function 404a, a setTimeoutAt(java.util.Date date) function 404b, and so forth for application code 120 to set an “alarm” after n elapsed units of time or at a specific moment in time.

In addition, the Timer interface includes a callback function 404c for handling alarm events generated by external entity 102 e.g., by passing them to application 140 asynchronously, when the timer expires at the requested time. In one embodiment, callback declarations are functions defined in a nested interface named “Callback” as depicted in FIG. 4.

The runtime, compile time and design time implementation classes are specified as “com.beajws.private.Timerlmpl” 412, “com.beajws.private. Timer Validator” 414, and “com.beajws.private.TimerDesigner” 416 respectively. The specifications are made using property settings. In one embodiment, property settings are specified in an annotation form in a comment section. As those skilled in the art will recognize, property settings in this example are specified using the special Javadoc annotation @implementation 410.

Except for the exploitation of extensible, resource and/or builder interfaces 114-118, usage of proxy context object 158, and implementation of facilities in conformance to the expected execution paradigm, the core constitution of each implementation class, whether it is runtime, compile time, or design time, is application dependent. That is, they vary depending on the behavior of and services offered by external entity 102, and the nature of the functions.

However, as alluded earlier, the runtime implementation class is expected to implement the functions of the proxy object definition 104 in the execution context of an embodiment either directly through built-in functions 111 or indirectly through the “invoke” function of extensible interface 118.

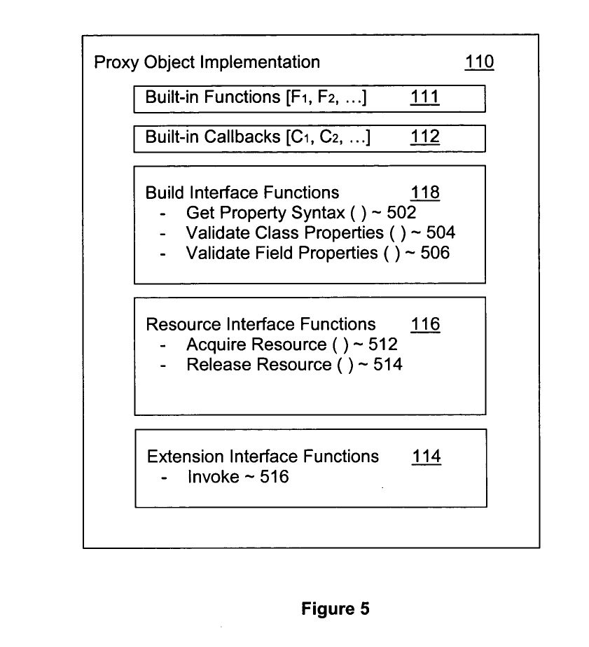

FIG. 5 illustrates proxy object implementation 110 in further detail, in accordance with one embodiment. As illustrated, for the embodiment, proxy object implementation 110 includes built-in functions 111, built-in callback functions 112, builder interface 114, resource interface 116 and extension interface 118.

As described earlier, builder interface 114, when implemented by a compile time implementation class, assists compiler 130 to validate the properties defined by the proxy object definition 104 and used by application code 120 are supported by proxy object implementation 110. In addition, builder interface can be used by an integrated development environment to help the developer understand where and how properties can be used.

Resource interface 116, when implemented by a runtime implementation class, assists the runtime implementation class in acquiring and releasing resources, such as database connections and file handles.

Extensible interface 118, when implemented by a runtime implementation class, enables proxy object definitions 104 to declare new functions, not directly supported by proxy object implementation 110, without defining how those functions are implemented. For the illustrated embodiment, builder interface 114 includes in particular a Get Property Syntax function 502, Validate Class Properties function 504, and Validate Field Properties function 506. As the names of these functions suggest, when invoked, these functions return a description of the valid property syntaxes for the proxy object and validate the class and field level properties of the proxy object.

In one embodiment, when invoked, Get Property Syntax function 502 returns a URL identifying a file provided by the developer of the compile time implementation class, describing the valid property syntax in the form of a XML file.

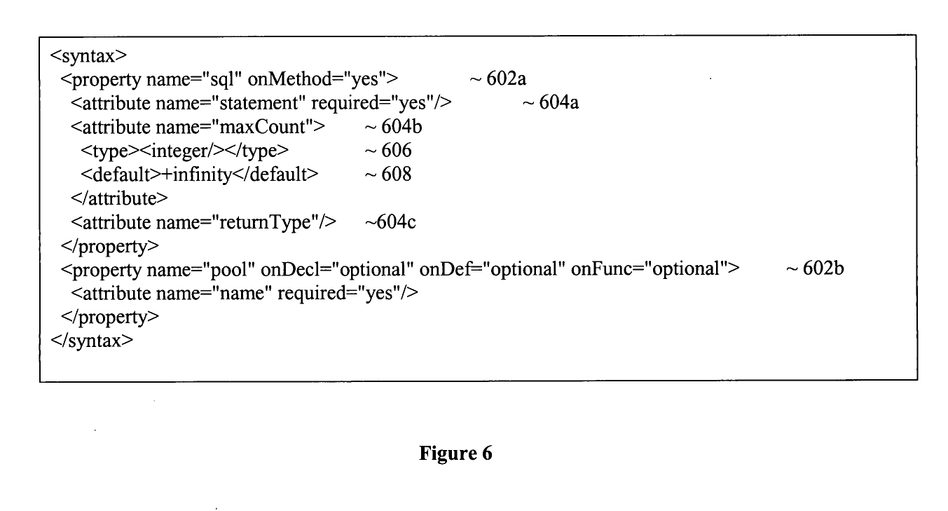

An example snippet of such a XML file is illustrated in FIG. 6. As illustrated, such snippet can specify the name of a property, 602a or 602b, the attributes of a property, 604a, 604b, or 604c, including whether they are required, the data type of the attribute values 606, and if applicable, their default values 608.

For the example snippet, it specifies that the “@sql” property is only allowed in front of proxy object definition functions 108, and the presence of the property is required here. The @sql property can have statement, maxcount, and returnType attributes. The statement attribute is required. Unless specified otherwise, all attributes can be assigned values. Maxcount and returnType are optional. Maxcount takes an integer value, and the default value is infinity. Unless specified otherwise, attributes (such as Statement and returnType) take string values, and the default value is the empty string. The @pool annotation is allowed in front of proxy object declarations 122, proxy object definition functions 109, and proxy object definitions 104, and is optional in all these locations. Finally, the @pool annotation can have a name attribute, which should be present and have a string value.

In alternate embodiments, the information can be provided and/or returned in other formats or using other data organization techniques.

Implementations of Get Propoerty Syntax function 502, Validate Class Properties function 504, and Validate Filed Properties function 506 are within the ability of those skilled in the art, accordingly will not be further described.

Implementing the builder interface 118 enables a compile time implementation class to use these functions to provide the expected syntax, and to validate the meta data, for compiler 130.

Referring back to FIG. 5, for the illustrated embodiment, resource interface 116 includes an Acquire Resource function 512 and Release Resource function 514. As the names of these functions suggest, function 512 enables proxy object implementation 110 to acquire system resources, such as database connections and files handles, needed by the implementation before the run-time creates each new instance of a proxy and function 514 enables proxy object implementation 110 to release resources after the run-time destroys each instance of a proxy object. Similarly, implementations of Acquire Resource function 512 and Release Resource function 514 are within the ability of those skilled in the art, accordingly will not be further described.

Still referring to FIG. 5, for the illustrated embodiment, extension interface 114 includes an Invoke Object function 516. Invoke object function 516 is designed to handle invocation of custom methods declared by proxy object definitions 104. Thus, proxy object definitions 104 can declare new functions 109 not specifically implemented by built-in functions 111 of proxy object implementation 110. During runtime, when application code 120 invokes new functions 109, proxy object 154 will dispatch them to invoke function 516 of proxy object implementation 110. Invoke function 516 of proxy object implementation 110 can access the name, arguments, return type, properties and other meta-data related to proxy object invocation 144 via proxy context object 158 to determine the desired semantics of the invoke operation. The access can be made using e.g. methods associated with proxy context object 158.

Similarly, implementation of Invoke Object function 516 is within the ability of those skilled in the art, accordingly will not be further described.

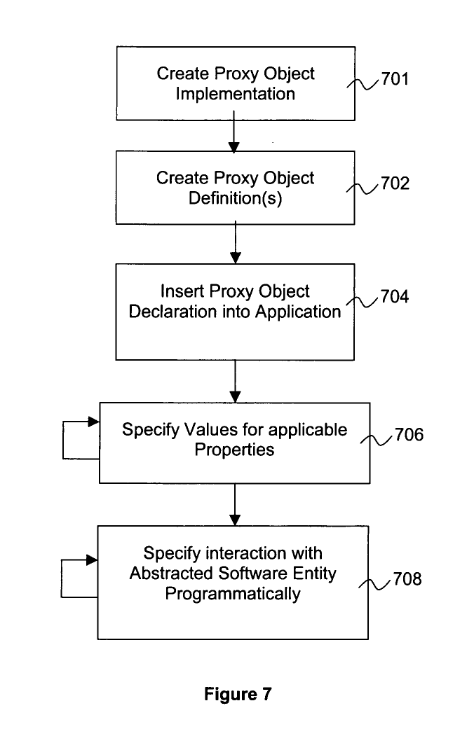

FIG. 7 illustrates the application development method of an embodiment, including usage of software abstractions for external entities, in accordance with one embodiment. As illustrated, at block 701, a proxy object implementation 110 is first created optionally including built-in functions, built-in callbacks, builder interface implementation, resource interface implementation and/or extensible interface implementation.

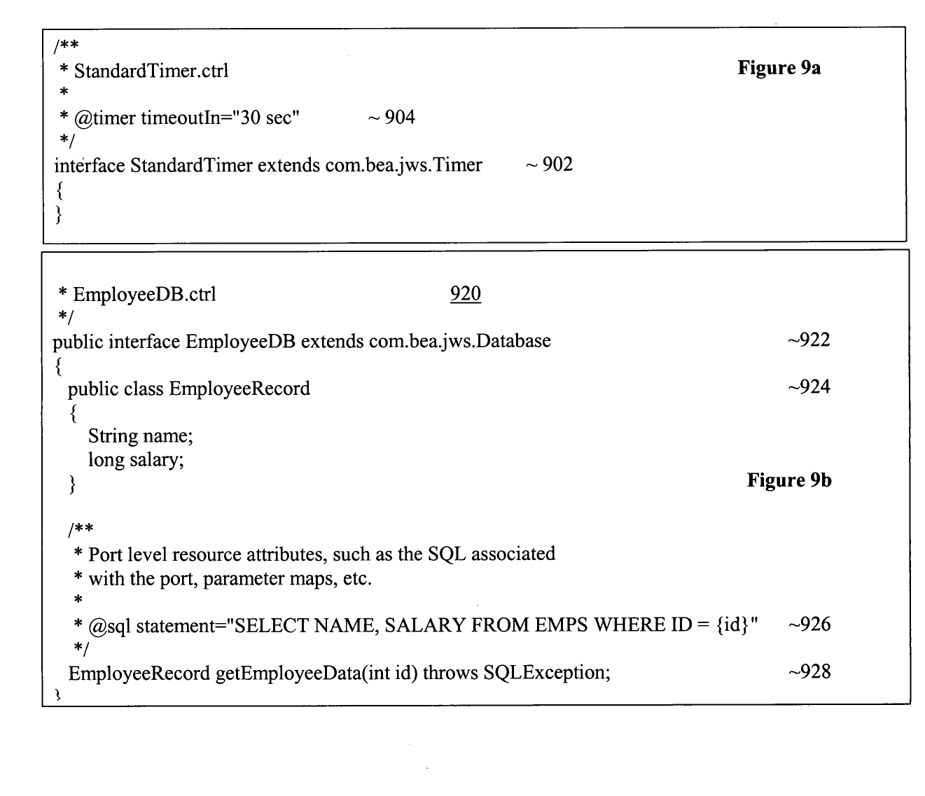

Then, at block 702, a proxy object definition 104 is created, extending the marker ProxyObject interface directly or indirectly through another proxy object definition. If proxy object definition extends ProxyObject marker interface directly it specifies the associated proxy object implementation 110 e.g. using an “implementation” property. A proxy object definition that extends the ProxyObject marker interface indirectly can also specify an associated implementation overriding the implementation associated with its base class. The proxy object definition can also specify new default property values and if implementation 110 is extensible specify new functions and callbacks. The proxy object definition can be made by the developer of application 120, developer of proxy object implementation 110 or another independent third party. As described earlier, a proxy object definition 104 is extensible if the associated implementation 110 implements extension interface 114. Example extensions will be described below referencing FIGS. 9a-9b.

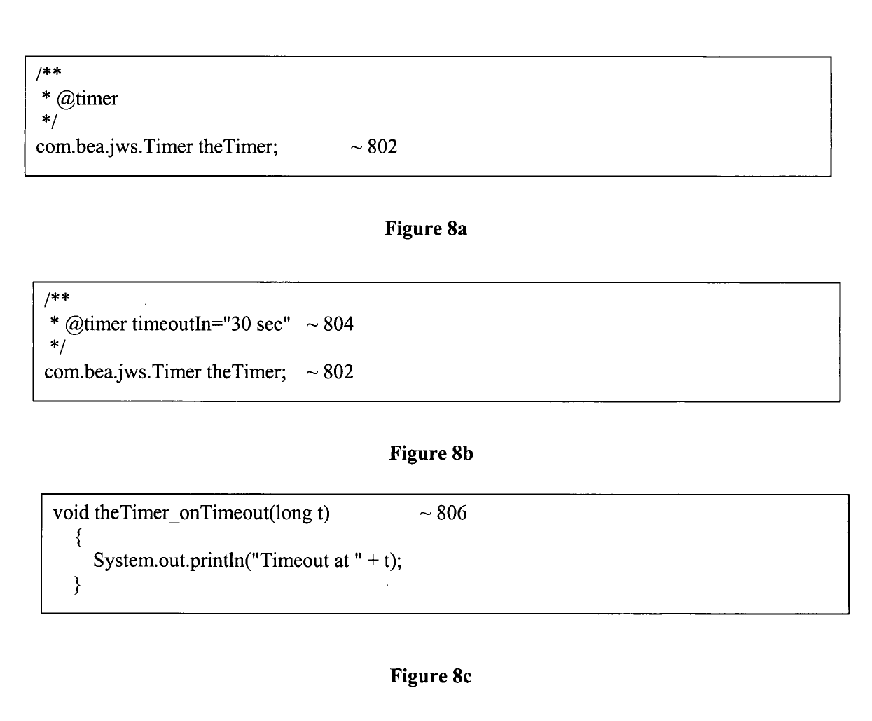

At block 704, a developer of application 120 inserts one or more proxy object declarations 122 into application code 120 referencing proxy object definition 104. As alluded to earlier, the proxy object definition 104 can be the base proxy object definition 104 e.g. offered by the developer of the software abstraction of external entity 102 or it can be a customized version of the proxy object definition 104. An example declaration will be described below referencing FIG. 8a.

At block 706, a developer of application 120 specifies values for applicable ones of the properties of the proxy object definition 104. In one embodiment, the specification is in annotation form within a comment section of the source file. An example specification will be described below referencing FIG. 8b.

Having inserted proxy object declarations 122, and for applicable ones, if any, the property values, at block 708, an application 120 can interact with external entity 102 programmatically, using the functions defined by proxy object definitions 104 and implemented by implementation 110 either directly using built-in functions 111 or indirectly by the extensible interface 118.

As alluded to earlier, a developer of application 120 can also specify a handler for asynchronous events generated and sent by an asynchronous event generation function of the software abstraction of external entity 102. An example specification will be described below referencing FIG. 8c.

FIG. 9a illustrates a simple proxy object definition 104 that extends the example Timer interface shown in FIG. 4 by specifying a new interface declaration 902 and a new default property setting 904. The StandardTimer proxy object definition of FIG. 9a inherits all the functions and properties defined by the proxy object definition in FIG. 4, but changes the default setting for the “timeoutln” attribute of the @Timer property to 30 seconds. Consequently, applications 120 that use the StandardTimer will not need to specify the timeoutln attribute or the @Timer property if 30 seconds is acceptable.

Those skilled in the art of course will recognize that the above example is purposely kept simply to facilitate illustration and ease of understanding. In practice, a proxy object definition of an embodiment can customize default property settings much more extensively. In particular, a proxy object definition can also customize properties associated with property object functions and callbacks. In addition, property object definitions can be customized multiple times successively, that is a customized property object definition can itself be further customized.

When a proxy object implementation 110 implements extensible interface 114, it is also possible to customize the interface of associated proxy object definitions 104 by adding new function declarations 109 and callback declarations 108. FIG. 9b illustrates an example proxy object definition 920 named EmployeeDB that customizes the com.beajws.Database proxy object definition by declaring a new function named getEmployeeData. The interface declaration 105 on line 922 declares that the EmployeeDB interface extends the com.beajws.Database interface, which in turn extends the com.beajws.ProxyObject interface (not shown) identifying the EmployeeDB interface as proxy object definition of an embodiment. As such, the EmployeeData interface will inherit all the property settings, functions and callbacks declared in the Database proxy object definition and all proxy object definitions it extends.

Line 928 is a function declaration adding the function getEmployeeData to the existing list of functions inherited from the Database proxy object definition. This function can be invoked by application 140 at run-time to interact with the external employee database described by proxy object definition 920. Note, however, that none of the proxy object definitions or proxy object implementation specifically implement the getEmployeeData function. The details of exactly how invocations to functions 109 declared by proxy object declarations 104 are handled at run-time is further specified below.

Line 926 is a property setting describing the desired semantics of the getEmployeeData function and line 924 defines the EmployeeRecord data structure returned by the getEmployeeData function. All interface declarations 105, property settings 106, callback declarations 108, function declarations 109 and associated definitions (e.g., the EmployeeRecord data structure) are stored by compiler 130 in meta-data 152 and available to proxy object 154 at run-time via proxy context object 158. This meta-data assists proxy object 154 and proxy object implementation 110 to provide implementations of functions 108 and callbacks 109 declared by proxy object definitions 104.

FIG. 8a illustrates an example proxy object declaration 122 as it might be found in application code 120. Line 802 declares a new proxy object named theTimer that implements the com.beajws.Timer proxy object definition from FIG. 4.

FIG. 8b illustrates an almost identical example proxy object declaration with the timeoutIn attribute of the @Timer property set to the value 30 sec, 804. In this example, the value of the timeoutIn property is specified as a Javadoc annotation in a comment section. Application code 120 can invoke functions on this object to interact with the associated external timer entity.

In addition, the developer of application code 120 can specify handlers for asynchronous events generated by external entity 102.

FIG. 8c illustrates one such example asynchronous event handler for handling asynchronous timeout event notifications 806. In this example, the handler is written as a specially named function in application code 120. The function name is formed by appending the name of the asynchronous event to be handled (i.e., “on Timeout”) to the name of the associated proxy object (i.e., “theTimer”). As we will see below, at run-time, proxy object 154 will forward asynchronous events to the appropriate event handling code 146 in application 140.

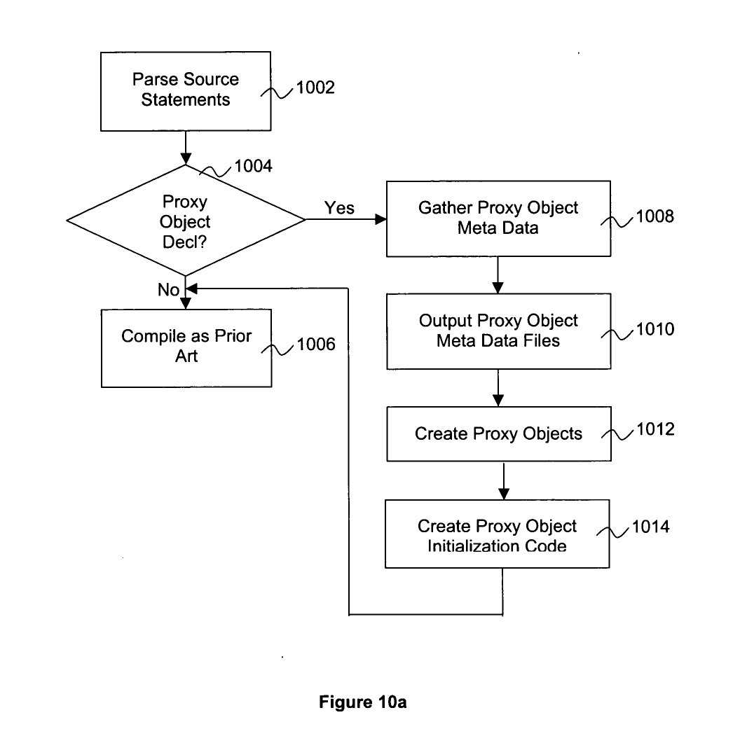

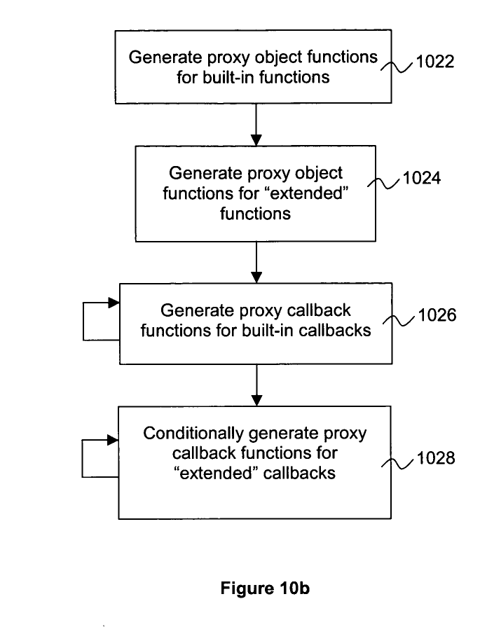

FIGS. 10a-10b illustrate the operational flow of the relevant aspects of compiler 130, in accordance with one embodiment. As illustrated first by FIG. 10a, at block 1002, compiler 130 parses the source statements of application code 120 to determine the language elements present in the source statements. In particular, compiler 130 determines if any proxy object declarations of an embodiment are included in application code 120 by looking for objects declared to implement interfaces derived from proxy object marker interface 302, block 1004.

If no proxy object declarations of an embodiment are found, application code 120 is compiled as other software entities in the prior art, block 1006. The exact nature of this compilation is language and compiler implementation dependent. If at least one proxy object declaration of an embodiment is found, compiler 130 gathers the meta data necessary to describe each proxy object of an embodiment, block 1008.

In one embodiment, the meta data gathering operation includes identifying and extracting property settings 123 from application code 120 and default property settings 106 from all associated proxy object definitions 104, including proxy object definitions from which the proxy object definitions identified in proxy object declarations 122 are derived. In addition, meta data gathering includes identifying and extracting the names and signatures of declared interfaces 105, declared functions 109 and declared callbacks 108 from all associated proxy object definitions 104 as well as the names and signatures of built-in functions 111 and built-in callbacks 112 of proxy object implementation 110. In one embodiment, property settings are specified using a Javadoc annotation form in the comment sections of the source file of application code 120 and proxy object definitions 104. Compiler 130 includes a property processor (not shown) responsible for parsing the comment sections of the source file of application code 120 and proxy object definitions 104.

In one embodiment, consultation with the compile time implementation class is also performed by the property processor of compiler 130 to verify the property settings and associated properties are implemented and allowed by proxy object implementation 110. In one embodiment, the consultation is made through the functions of builder interface 118.

Upon gathering up the meta data necessary to describe each proxy object of an embodiment, compiler 130 outputs one or more meta data files 152 containing the gathered meta data, block 1010, for use by the corresponding proxy object 154 during runtime.

Then, compiler 130 generates a proxy object 154 for each proxy object definitions 104 associated with (e.g., referenced by) proxy object declarations 122 to facilitate the interaction between the application 140 and the external entity 102. This process is described in more detail below referencing FIG. 10b.

Further, compiler 130 generates proxy initialization code 142 for each proxy object declaration 122, block 1014. At run-time, each instance of proxy initialization code 142 creates a proxy object implementing the interface identified in the associated proxy object declaration 122, assigns the proxy object to the proxy object variable identified in the associated proxy object declaration 122 and registers the proxy object with asynchronous event router 156 to receive all asynchronous events from associated external entity 102.

Next, compiler 130 compiles the rest of the application code 120 as in the prior art inserting proxy initialization code 142 to run prior to associated proxy invocation code 144 and event handling code 146, block 1006.

Further, implementation of the property processor is within the ability of those skilled in the art, and will not be further described.

FIG. 11 illustrates proxy object 154 generated by compiler 130 in more detail. Proxy object 154 includes function interfaces 1122-1124 and callback interfaces 1126-1128 declared by proxy object definitions 104 and represented by black circles in FIG. 11. In addition, proxy object 154 includes proxy object implementation 110, including built-in functions 111 and built-in callbacks 112 represented by white circles in FIG. 11. If proxy object implements extensible interface 116, proxy object implementation also includes invoke function 516 for handling invocations to function interfaces 1124 that don't have a corresponding built-in function 111.

Further, Proxy object 154 and proxy object implementation 110 have access to meta-data 152 via proxy object context 158 describing associated proxy object definitions 104 (including interface declarations, property settings, callback declarations and function declarations) and property settings 123. This meta-data can be used at runtime to determine the desired semantics of invocations to function interfaces 1124 that don't have a corresponding built-in function 111. In one embodiment, a reference to proxy object context 158 can be obtained by calling the global function getProxyContext( ) provided by runtime engine 150. At run-time, the getProxyContext( ) function will return the proxy object instance associated with the current proxy object invocation as described further below.

As described earlier, in various embodiments, proxy object context 158 includes various methods for facilitating access of the “context” information. In one embodiment, these methods include a getMetaData( ) method for getting meta data, and a getAttribute( ) method for getting particular property values. Meta data can e.g. include methods, arguments, fields, and/or annotations associated with the proxy object functions and callbacks.

In one embodiment, proxy object context 158 also includes a getInstanceID( ) to facilitate obtaining the unique ID of the proxy object instance, and a sendEvent( ) for sending asynchronous events to application 140. In one embodiment, sendEvent( ) determines the appropriate event handler 146 to invoke by appending the name of the event to the name of the proxy object variable specified in proxy object declaration 122. It extracts the event name and proxy object variable name from meta-data 152. Implementation of these methods are within the ability of those skilled in the art, accordingly will not be further described. In alternate embodiments, an embodiment can be practiced with more or less methods associated with proxy object context 158.

As described earlier, at block 1012, compiler 130 generates proxy object 154, more specifically, using information collected from application code 120, proxy object definitions 104 and proxy object implementation 110. As illustrated in FIG. 10b, it generates a proxy object function 1122 for each function declaration 109 in proxy object definitions 104 that have a corresponding built-in function 111 in proxy object implementation 110, block 1022. Each implementation of proxy object functions 1222 simply calls the corresponding built-in function 111 of proxy object implementation 110 passing in provide parameters and returns the result.

If proxy object implementation 110 implements extensible interface 114, compiler 130 also generates proxy object functions 1124 for each function declaration 109 in proxy object definitions 104 that do not have a corresponding built-in function 111 in proxy object implementation 110, block 1024. Each implementation of proxy object functions 1224 invokes “invoke” function 516 passing the list of provided parameters and returns the result.

Similarly, compiler 130 generates proxy object callback functions 1126 for each callback declaration 108 in proxy object definitions 104 that have a corresponding built-in callback 112 in proxy object implementation 110, block 1026. Each implementation of callback functions 1126 simply calls the corresponding built-in callback 112 passing provided parameters and returning any results.

Further, for each callback declaration 108 in proxy object definitions 104 that does not have a corresponding built-in callback 112 in proxy object implementation 110, compiler 130 determines whether an appropriate event handler 146 exists in application 140 to handle the call back, block 1028. If an appropriate event handler 146 exists, compiler 130 generates a proxy callback function 1128, which, invokes the appropriate event handler 146 passing in provided parameters and returns any results generated by the event handler, block 1028. If an appropriate event handler does not exist, compiler 130 generates and error, block 1028. In one embodiment, compiler 130 identifies the appropriate event handler and determines its existence by searching for a function in application 140 with a special name formed by appending the name of the associated event to the name of the associated proxy object variable specified in proxy object declaration 122. The names of the appropriate event and proxy object variable are extracted from meta-data 152.

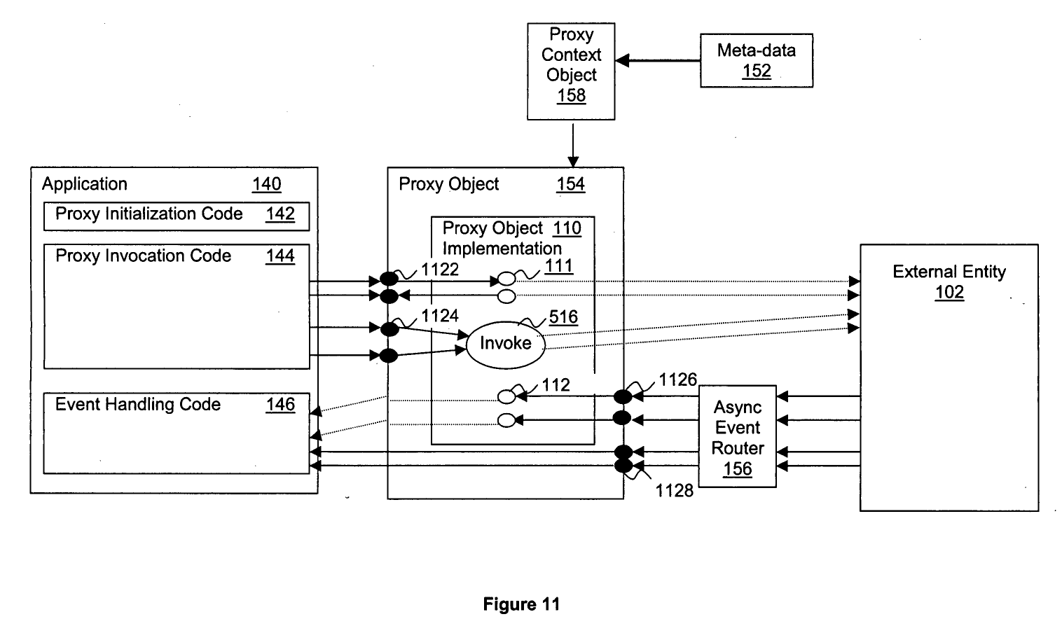

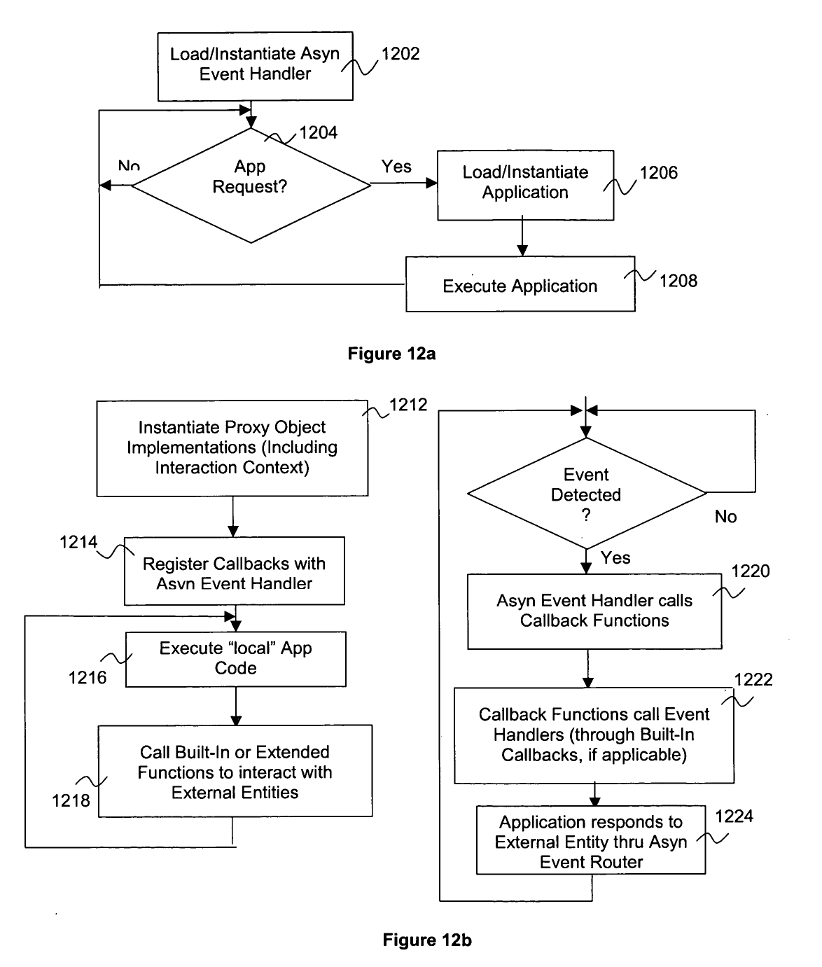

FIG. 12a illustrates the relevant operational flow of runtime engine 150, in accordance with one embodiment. When the runtime engine 150 is first instantiated, it initializes the runtime environment, including in particular, the creation of an instance of asynchronous event router 156, block 1202. In one embodiment, asynchronous event router 156 is a server component that listens for messages using various networking protocols and forwards them to clients that have registered for events with matching characteristics (e.g., based on message address or content). In one embodiment, asynchronous event router 156 is a Java Servlet that listens for XML messages using Internet protocols, such as HTTP. In one embodiment, event router 156 listens for messages using queuing protocols, such as JMS.

Upon initialization of the runtime environment, runtime engine 150 waits for requests to execute applications, block 1204. At block 1206, runtime engine 150 loads application 140, whose execution is requested (or creates a new instance of the application if the application has been previously loaded for an earlier execution request). After loading and/or creating an instance of application 120, execution engine 150 “executes” the application 120, or more specifically, transfers execution control to application 120.

FIG. 12b illustrates a typical execution flow, in accordance with one embodiment. As designated by compiler 130, if application 140 includes proxy initialization code 142 and so forth, proxy initialization code 142 executes prior to proxy invocation code 144 and event handling code 146.

As previously described, proxy initialization code 142 instantiates a proxy object for each proxy object declaration 122 and assigns the proxy object to the associated variable specified in proxy object declaration 122, block 1212. Then, proxy initialization code 142 registers all callbacks functions 108 declared in associated proxy object definitions 104 and implemented by proxy object 154 with asynchronous event router 156 as handlers for asynchronous events from external entity 102, block 1214.

Thereafter, execution engine 150 continues to execute application 140. In the course of execution, if application 140 has a need to interact with external entities, it invokes proxy object functions 1122-1124 using the associated variable declared in proxy object declaration 122, block 1218. As designated by compiler 130, proxy object functions 1122-1124 create an instance of proxy context object 158 associated with the invoked function using a function invocation ID. In one embodiment a separate thread is created for each function invocation and the thread ID is used as the function invocation ID.

Functions 1122 further invoke associated built-in functions 111 of proxy object implementation 110, block 1218. The behavior of built-in functions 111 varies for each proxy object implementation 110 and depends largely on the nature of associated external entity 102. If provided, proxy object functions 1224 invoke the “invoke” function 516 of proxy object implementation 110, block 1218.

In one embodiment, built-in functions send messages to external entity 102 via Internet or messaging protocols and optionally wait for a response. In one embodiment, if a response is received, built-in function 111 returns a representative result, which is in turn returned to proxy invocation code 144 inside application 140 by proxy object function 1122. In one embodiment, built-in functions include a callback location and proxy object instance identifier in messages sent to external entity 102 to facilitate the generation and routing of callback events generated by external entity 102.

Both built-in functions 111 and the “invoke” function 516 of extensible interface 118 can obtain a reference to the current proxy context object 158 for accessing meta-data 152 by calling the global getProxyContext( ) function provided by run-time engine 150. The getProxyContext( ) function finds and returns the appropriate context object based on the invocation ID associated with the current function invocation. In one embodiment, a separate thread is created for each function ID and the current invocation ID is the same as the current thread ID.

Like built-in functions 111, the behavior of invoke function 516 varies for each proxy object implementation 110 and depends largely on the nature of the associated external entity 102. In one embodiment, invoke function 516 accesses meta-data 152 via proxy context object 158 to determine the desired semantics of proxy object functions 1124, then sends appropriate messages to external entity 102, optionally waits for a response and returns a representative result to proxy object function 1124, which in turn returns the result to proxy invocation code 144 in application 140. In one embodiment, invoke function 516 includes a callback location and proxy object instance identifier in messages sent to external entity 102 to facilitate the generation and routing of callback events generated by external entity 102.

Upon receiving a request from application 140, external entity 102 handles the request in an application dependent manner and optionally records a callback address and instance identifier provided by the request. External entity 102 can generate asynchronous events detectable by asynchronous event handler 156 and can specify the recorded callback address and instance identifier to facilitate handling of the event. In one embodiment, external entity 102 provides event notifications to asynchronous event router 156 in the form of messages.

At block 1220, as asynchronous event router 156 detects an event from external entity 102, it checks its list of registered handlers and invokes the designated callback function 1126-1128 of the designated proxy object passing a representation of the event as a set of parameters. In one embodiment, asynchronous event router 156 uses a provided callback location to identify which registered handler and callback function should handle the event. In one embodiment, asynchronous event router 156 uses a provided instance identifier to determine which instance of the identified handler should receive the callback.

As designated by compiler 130, at block 1222, proxy object callbacks 1126 invoke associated built-in callbacks 112 of proxy object implementation 110 passing along any provided parameters. The behavior of built-in callbacks 112 varies for each proxy object implementation 110 and depends largely on the nature of associated external entity 102.

In one embodiment built-in callback 112 can invoke an appropriate event handler 146 in application 140 passing provided parameters and optionally wait for a response, block 1222.

Upon receipt of a response to the event for external entity 102, built-in callback 112 returns any returned result to proxy object callback function 1126, which returns it to asynchronous event router 152, which provides the result to external entity 102, block 1224. In one embodiment, the result is returned to the external entity in the form of a representative message.

Also as designated by the compiler, proxy object callbacks 1128 do not have corresponding built-in callbacks 112 and are therefore forwarded directly to appropriate event handlers 146 with any corresponding results returned optionally to external entity 102 via proxy callback function 1128 and asynchronous event router 156, block 1224. In one embodiment, appropriate event handlers 146 are identified as specially named functions defined in application 140. In one embodiment, this naming convention is determined by appending the name of proxy callback function 1126-1128 corresponding to callback declarations 108 to the name of the proxy object variable declared in proxy object declaration 122 in application code 120.

For some applications, there is a need to manage an n-way interaction with an external entity. I.e., a single instance of application 140 can need to simultaneously interact with multiple instances of external entity 102. The required number of instances can vary based on run-time data; therefore, it can not be possible to determine how many proxy object instances will be required when application code 120 is written. For example, an application instance can have a need to disassemble the line items of a purchase order and conduct a concurrent conversation with a separate instance of the external entity for each line item.

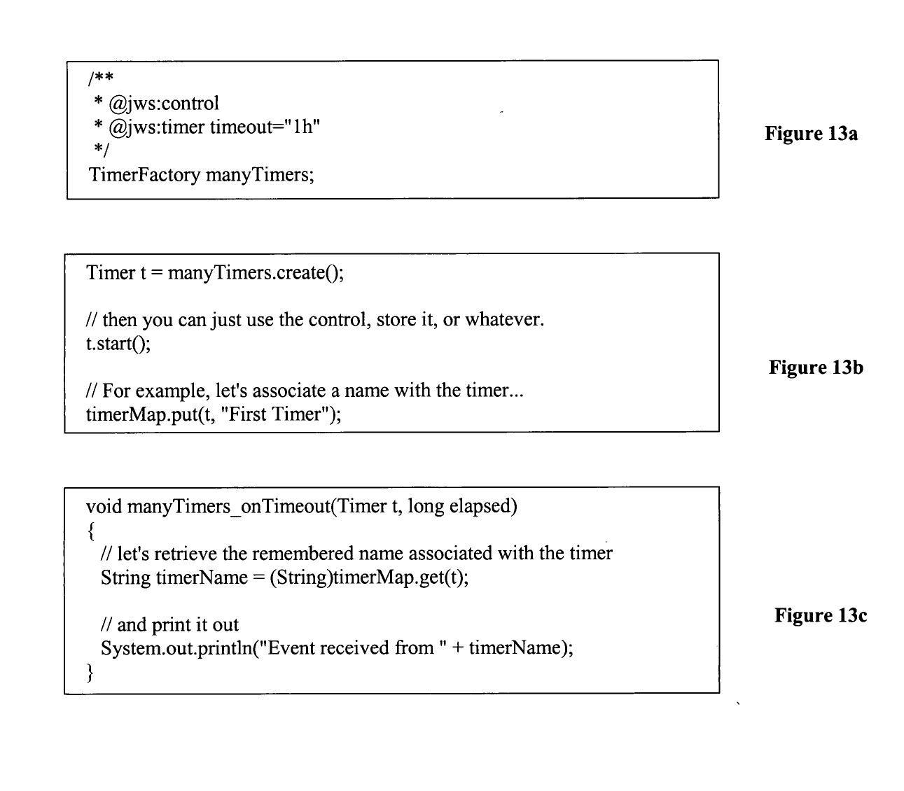

In various embodiments, to address this need, the application developer can specify a proxy object factory in proxy object declaration 122 instead of specifying a single proxy object. For these embodiments, compiler 130 automatically generates a “factory class” for each proxy object 154. For example, for a proxy object 154 named MyService, a factory class (not separately shown) by the name MyServiceFactory is automatically generated. FIG. 13a illustrates an example proxy object factory declaration in one embodiment corresponding to the “Timer” proxy object definition illustrated in FIG. 4.

In some or all of these embodiments, the automatically generated proxy object factory can include a create( ) function to enable application 140 to control the creation of new proxy object instances and a destroy( ) function to enable application 140 to control the destruction of previously created proxy object instances. As such, application 140 can create as many instances of the proxy object as required at run-time. FIG. 13b illustrates how application code 120 might use the create( ) function in one embodiment to generate a new instance of the “Timer” proxy object and use the resulting proxy object to interact with the associated external entity.

Each automatically generated proxy object factory can be used by a software application to interact with the corresponding external entity in a n-way interaction, substantially as earlier described for the singleton case, referencing FIGS. 8a-8c. The proxy object factory behaves as if the annotations (i.e. usage specifications) were in front of instances created by the proxy object factory.

To facilitate proper asynchronous event routing, developer of application code 120 names associated event handlers 124 using the name of the proxy object factory variable instead of a proxy object variable name. In addition, the developer specifies a “proxy object instance” variable as a predetermined parameter, e.g. the first parameter, of each event handler 124. Proxy object 154 will provide the appropriate proxy object instance for each callback event, so application 140 can determine which instance of external entity 102 generated the event and interact with it using the provided proxy object instance. FIG. 13c illustrates an event handler 124 in one embodiment developed to handle asynchronous events from Timer proxy objects generated by the proxy object factory named “manyTimers” declared in FIG. 13a. As illustrated, on invocation, the first argument “t” will reference the specific instance of the Timer proxy object associated with the instance of the external entity that generated the event.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a storage medium (media) having instructions stored thereon/in which can be used to program a computer to perform any of the features presented herein. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, execution environments/containers, and user applications.

The foregoing description of the preferred embodiments of the present invention has been provided for the purposes of illustration and description. It is not intended to be exhaustive or to limit the invention to the precise forms disclosed. Many modifications and variations will be apparent to the practitioner skilled in the art. Embodiments were chosen and described in order to best describe the principles of the invention and its practical application, thereby enabling others skilled in the art to understand the invention, the various embodiments and with various modifications that are suited to the particular use contemplated. It is intended that the scope of the invention be defined by the following claims and their equivalents.

What is claimed is:

1. A method for creating a proxy object capable of communication with an external entity, comprising:
specifying a proxy object definition for the proxy object wherein the proxy object definition defines a first function for communicating with the external entity;
specifying at least one implementation class for the proxy object definition, wherein the at least one implementation class does not implement the first function; and
wherein the at least one implementation class includes functionality to support one of: proxy object design, software compilation and software execution.

2. The method of claim 1, further comprising:
compiling the proxy object definition and/or the at least one implementation class.

3. The method of claim 1 wherein:
the at least one implementation class is specified with a source code annotation.

4. The method of claim 1, further comprising:
specifying at least one callback declaration.

5. The method of claim 1 wherein:
the functionality to proxy object software design includes a wizard that can guide the creation of the proxy object.

6. The method of claim 1 wherein:
the functionality to support software compilation includes at least one function to validate function calls and property settings in source code.

7. The method of claim 1 wherein:
the functionality to support software execution includes at least one function to acquire and release at least one resource and includes the ability to invoke a function on the external entity.

8. The method of claim 1 wherein:
the external entity can be one of: a database, a legacy system, and a software application.

9. The method of claim 1 wherein:
the proxy object can inherit from a proxy object interface declaration at least one of: a function, a property and a callback.

10. The method of claim 1 wherein:
the proxy object definition includes a declaration of the first function.

11. A method for a proxy object to communicate with an external entity wherein the proxy object has an implementation class, said method comprising:
invoking a first function on the external entity via the proxy object, wherein the first function is not defined by the implementation class; and
dynamically determining the whether or not the first function invocation is proper based on metadata derived from a proxy object definition.

12. The method of claim 11 wherein:
the metadata includes at least one of the following: a proxy object interface declaration, a property setting, a callback declaration, and a function declaration.

13. The method of claim 11, further comprising:
invoking via the proxy object a callback function in an application based on receipt of an asynchronous event from the external entity.

14. The method of claim 11 wherein:
the implementation class is specified with a source code annotation.

15. The method of claim 11 wherein:
the implementation class includes at least one function to acquire and release at least one resource and includes the ability to invoke a function on the external entity.

16. The method of claim 11 wherein:
the external entity can be one of: a database, a legacy system, and a software application.

17. The method of claim 11 wherein:
the proxy object can inherit from a proxy interface declaration at least one of: a function, a property and a callback.

18. The method of claim 11 wherein:
the proxy object definition includes a declaration of the first function.

19. A system for creating a proxy object capable of communication with an external entity, comprising:
a proxy object definition for the proxy object wherein the proxy object definition defines a first function for communicating with the external entity;
at least one implementation class for the proxy object definition, wherein the at least one implementation class does not implement the first function;
a compiler capable of compiling the proxy object definition and the at least one implementation class; and
wherein the at least one implementation class includes functionality to support one of: proxy object design, software compilation and software execution.

20. The system of claim 19, further comprising:
the compiler is capable of generating metadata that can be used by the proxy object at runtime to invoke the first function.

21. The system of claim 19 wherein:
the at least one implementation class is specified with a source code annotation.

22. The system of claim 19, further comprising:
at least one callback declaration.

23. The system of claim 19 wherein:
the functionality to proxy object software design includes a wizard that can guide the creation of the proxy object.

24. The system of claim 19 wherein:
the functionality to support software compilation includes at least one function to validate function calls and property settings in source code.

25. The system of claim 19 wherein:
the functionality to support software execution includes at least one function to acquire and release at least one resource and includes the ability to invoke a function on the external entity.

26. The system of claim 19 wherein:
the external entity can be one of: a database, a legacy system, and a software application.

27. The system of claim 19 wherein:
the proxy object can inherit from a proxy object interface declaration at least one of: a function, a property and a callback.

28. The system of claim 19 wherein:
the proxy object definition includes a declaration of the first function.

29. A system for an application to communicate with an external entity, comprising:
an asynchronous event router capable of accepting asynchronous events from the external entity and forwarding them to one of: the application and a proxy object;
the application capable of invoking a function on the proxy object and capable of accepting asynchronous events from the asynchronous event router;
the proxy object capable of accepting asynchronous events from the asynchronous event router and invoking the function on the external entity;
wherein if the function is not defined by the proxy object, the proxy object is capable of dynamically determining whether or not the function invocation is proper based on the metadata.

30. The system of claim 29 wherein:
the external entity can be one of: a database, a legacy system, and a software application.

31. The system of claim 29 wherein:
the proxy object can inherit from a proxy object interface declaration at least one of: a function, a property, and a callback.

32. A machine readable medium having instructions stored thereon that when executed by a processor cause a system to:
invoke a first function on an external entity via a proxy object, wherein the first function is not defined by the implementation class; and
dynamically determine the whether or not the first function invocation is proper based on metadata derived from a proxy object definition.

33. The machine readable medium of claim 32 wherein:
the metadata includes at least one of the following: a proxy object interface declaration, a property setting, a callback declaration, and a function declaration.

34. The machine readable medium of claim 32, further comprising instructions that when executed cause the system to:
invoke via the proxy object a callback function in an application based on receipt of an asynchronous event from the external entity.

35. The machine readable medium of claim 32 wherein:
the implementation class is specified with a source code annotation.

36. The machine readable medium of claim 32 wherein:
the implementation class includes at least one function to acquire and release at least one resource and includes the ability to invoke a function on the external entity.

37. The machine readable medium of claim 32 wherein:
the external entity can be one of: a database, a legacy system, and a software application.

38. The machine readable medium of claim 32 wherein:
the proxy object can inherit from a proxy interface declaration at least one of: a function, a property and a callback.

39. The machine readable medium of claim 32 wherein:
the proxy object definition includes a declaration of the first function.

40. A computer data signal embodied in a transmission medium, comprising:
a code segment including instructions to invoke a first function on an external entity via a proxy object, wherein the first function is not defined by the implementation class; and
a code segment including instructions to dynamically determine the whether or not the first function invocation is proper based on metadata derived from a proxy object definition.

41. The signal of claim 40 wherein:
the metadata includes at least one of the following: a proxy object interface declaration, a property setting, a callback declaration, and a function declaration.

42. The signal of claim 40, further comprising:
a code segment including instructions to invoke via the proxy object a callback function in an application based on receipt of an asynchronous event from the external entity.

43. The signal of claim 40 wherein:
the implementation class is specified with a source code annotation.

44. The signal of claim 40 wherein:
the implementation class includes at least one function to acquire and release at least one resource and includes the ability to invoke a function on the external entity.

45. The signal of claim 40 wherein:
the external entity can be one of: a database, a legacy system, and a software application.

46. The signal of claim 40 wherein:
the proxy object can inherit from a proxy interface declaration at least one of:
a function, a property and a callback.

47. The signal of claim 40 wherein:
the proxy object definition includes a declaration of the first function.
